(19) United States
(12) Patent Application Publication
(10) Pub. No.: US 2006/0124008 A1
(43) Pub. Date: Jun. 15, 2006

(54) Device and method for producing flexographic plates using digital imaging, for newspaper printing

(75) Inventors: Elmar Kessenich, Ludwigshafen (DE); Uwe Stebani, Florsheim-Dalsheim (DE); Thomas Telser, Heidelberg (DE); Hartmut Sandig, Frankenthal (DE)

Correspondence Address: CONNOLLY BOVE LODGE & HUTZ, LLP, P O BOX 2207, WILMINGTON, DE, 19899, US

(73) Assignee: BASF Drucksystem Gmbh, Stuttgart (DE)

(21) Appl. No.: 10/537,526

(22) PCT Filed: Nov. 27, 2003
(86) PCT No.: PCT/EP03/13366

§ 371 Date: Oct. 6, 2005

(30) Foreign Application Priority Data
Dec. 3, 2002 (DE) 102 56 614.3

(51) Int. Cl. B41C 3/08

(52) U.S. Cl. 101/401.1

(57) ABSTRACT

An apparatus for the in-line production of flexographic printing plates by means of digital imaging is used for the production of newspaper flexographic printing plates.

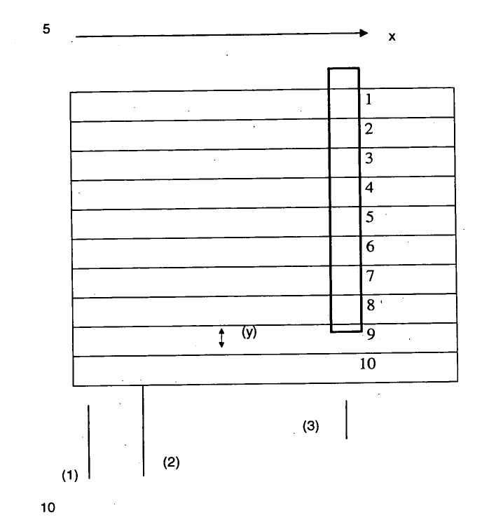

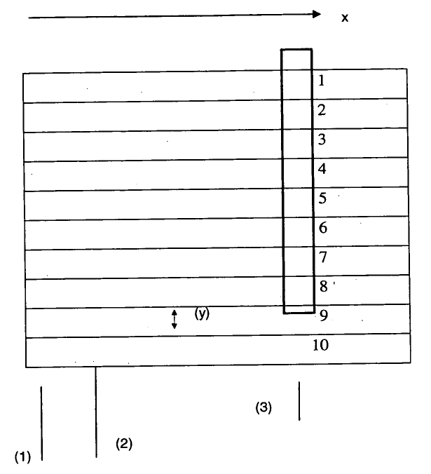

The present invention relates to an apparatus for the in-line production of flexographic printing plates by means of digital imaging and a process for the production of newspaper flexographic printing plates using the apparatus.

Nowadays, daily newspapers are generally produced by the offset printing process. Increasingly, however, the flexographic printing technique is also being used for printing daily newspapers, because flexographic printing has a number of technical advantages. In the flexographic printing process, for system-related reasons, printing can be started up much more quickly than in the offset process since, in contrast to the latter, no setting of the ink-water equilibrium is required. In addition to the time saving, this also means considerable saving of paper. Another disadvantage of offset printing is that it is effected with pasty, mineral oil-containing inks. In coldset offset printing, the oils remain for the most part in the paper, which results in significant amounts of black rub-off, especially on the fingers of the newspaper readers. In heatset offset printing, the mineral oils are released on drying of printing inks. In flexographic printing with water-based printing inks which are rapidly absorbed by the paper, the black rub-off is substantially reduced and no solvents are emitted. The printing presses can be cleaned in a simple manner with water.

However, the disadvantage of flexographic printing compared with offset printing is that the processing time for the photosensitive flexographic printing element up to the ready-to-print flexographic printing plate is considerably longer than the processing time in the case of offset printing plates. Typical processing times for commercial flexographic printing plates are of the order of magnitude of 6 h or more. For printing daily newspapers using flexographic printing plates, however, processing times of more than 30 min are scarcely acceptable any more. There is therefore a need for suitable processes and improved apparatuses for reducing the processing time.

Digital imaging of photosensitive flexographic printing elements is known in principle. Here, flexographic printing elements are not produced in the classical manner by placing a photographic mask on top, followed by exposure through the photographic mask. Rather the mask is produced in situ directly on the flexographic printing element by means of suitable techniques. Flexographic printing elements can be provided, for example, with opaque, IR-ablative layers (EP-B 654 150, EP-A 1 069 475) which can be ablated imagewise by means of IR lasers. Further known techniques include layers which can be recorded on by means of the inkjet technique (EP-A 1 072 953) or layers which can be recorded on thermographically (EP-A 1 070 989). After the imagewise recording on these layers by means of the techniques suitable for this purpose, the photopolymerizable layer is exposed to actinic light through the resulting mask.

For digital imaging of IR-ablative layers by means of IR lasers, laser apparatuses having rotating drums are usually used, as disclosed, for example, in EP-B 741 335. The flexographic printing element is clamped on the drum, the drum is caused to rotate and the IR-ablative layer is ablated imagewise by means of the laser while the drum rotates.

In our application DE 101 37 629.4, which was yet to be published at the priority date of the present application, we have proposed using thin photopolymerizable flexographic printing elements having a layer thickness of from 0.3 to 1 mm on a metallic substrate for the production of newspaper flexographic printing plates. The flexographic printing elements disclosed can be processed conventionally, i.e. with the aid of a photographic mask, or by means of digital imaging. The processing is effected by means of conventional apparatuses. With said flexographic printing elements, a substantial reduction in the processing time can be achieved. However, it is desirable even further to reduce the time for processing the photosensitive starting material to the finished flexographic printing plate.

Time delays occur in particular in the course of the IR ablation. The metal substrate is plastic to a certain extent. The substrate must be curved for mounting on the rotating drum of the laser apparatus for IR ablation, and it at least partly retains the curved shape even after removal from the drum. Since commercial washout apparatuses are intended for processing flat plates, the substrate must be straightened again before the further processing. First, this is time-consuming and secondly there is also the danger that the substrate will be buckled during straightening. However, buckling of the substrate leads to visible defects of the printed image. It would therefore be extremely desirable to be able to process flexographic printing plates flat in the course of the entire production process.

U.S. Pat. No. 5,919,378 discloses an apparatus for the fully automatic washing out and drying of circular printing plates (sleeves). The sleeves are transported through the apparatus by means of spindles, in which the sleeves are clamped. The sleeves are exposed imagewise outside the apparatus in a conventional manner.

DE-A 42 31 103 and EP-A 225 678 discloses apparatuses for transporting flexographic printing plates through a washout apparatus by means of which the plate is drawn through the apparatus by suitable pins or bars.

DE-A 100 57 061 discloses a printing apparatus for the imaging of offset printing plates, which has a plurality of printing heads.

An apparatus for processing digitally imageable, photopolymerizable flexographic printing elements to give finished flexographic printing plates, in particular newspaper flexographic printing plates, which is suitable for carrying out all steps of the production process and in which the plates are processed in the flat or level state, is, however, unknown to date.

It is an object of the present invention to provide an apparatus for the production of flexographic printing plates for newspaper printing by means of digital imaging, which apparatus comprises all processing steps in which the flexographic printing elements or plates can be processed without bending, i.e. in the flat state, and which permits faster processing. It is a further object of the present invention to provide a process for the production of flexographic printing plates for newspaper printing using said apparatus.

We have found that this object is achieved by an apparatus for the in-line production of flexographic printing plates by means of digital imaging, which at least comprises
(A) a unit for holding digitally imageable, photopolymerizable flexographic printing elements,
(B) a unit for the digital imaging of the flexographic printing element, which comprises at least two functional units of the same type,
(C) an exposure unit,
(D) a washout unit,
(E) a drying unit,
(F) an optional aftertreatment unit,
(G) an output unit for the flexographic printing plates obtained, and
(H) transport units for the flexographic printing elements or plates, which connects the units (A) to (G) to one another,
   the units (A) to (H) being designed so that the flexographic printing elements or plates are processed in the flat state.

We have furthermore found the use of the apparatus for the production of flexographic printing elements.

In a further aspect of the present invention, we have found a process for the production of flexographic printing plates for newspaper printing, in which the starting material used is a photopolymerizable flexographic printing element comprising—arranged on one on top of the other—at least
a flexible, metallic substrate,
a photopolymerizable layer which in turn comprises at least one elastomeric binder, ethylenically unsaturated monomers and a photoinitiator, and
a digitally imageable layer,
in which furthermore an apparatus according to the above definition is used and the process comprises the following steps:
(a) placing of the photopolymerizable flexographic printing elements in the holding unit (A),
(b) imagewise recording on the digitally imageable layer by means of the imaging unit (B) for producing a mask on the flexographic printing element,
(c) exposure of the flexographic printing element to actinic light by means of the exposure unit (C) through the mask produced,
(d) removal of unexposed parts of the flexographic printing element and of the residues of the digitally imageable layer thereof by means of a suitable solvent or of a suitable solvent combination in the washout unit (D),
(e) drying of the washed out flexographic printing plate at from 105 to 160° C. in the drying unit (E),
(f) optionally aftertreatment of the dried flexographic printing plate by means of UVA and/or UVC light and
(g) output of the finished flexographic printing plate,
   the flexographic printing element or the flexographic printing plate being transported by the transport means (H) from one unit to the respective next unit and not being bent during the entire processing procedure.

Regarding the present invention, the following may be stated specifically:

The novel apparatus comprises at least the units (A) to (G), which are connected to one another in a suitable manner by means of the transport units (H). The flexographic printing element or the flexographic printing plate is transported in the flat state through the apparatus and processed.

In a manner known in principle, flexographic printing element denotes the starting material for the process or an intermediate product, while the term flexographic printing plate denotes the finished flexographic printing plate.

In the context of this invention, the term unit is to be understood as functional unit. The novel apparatus may comprise individual apparatuses which in principle can also be operated separately and can be connected to one another by the transport units to form a larger apparatus. Preferably, however, it is an apparatus in which all functional units are integrated and in which the individual units can no longer be operated independently of one another. Particularly preferably, it is a closed apparatus in which flexographic printing elements are inserted only at one point and finished flexographic printing plates are removed at another point.

In the context of this invention, the term level processing or flat processing means that the process comprises no steps at all in which the flexographic printing element or the flexographic printing plate is consciously processed in the round or curved state, i.e. for example bent around a cylinder or means equivalent thereto, and the apparatus is designed accordingly. Level processing does not of course exclude the fact that, in the course of the process, a flexographic printing element might also be bent through a small angle unintentionally.

Unit (A) serves for holding digitally imageable, photopolymerizable flexographic printing elements as starting material for the process. In the simplest case, it may be a simple feed apparatus into which the flexographic printing elements are introduced individually and manually, for example by placing on a conveyor belt or placing in a feed apparatus. Preferably, however, the unit (A) comprises a magazine which contains a relatively large stock of flexographic printing elements, from which the flexographic printing elements are automatically removed as required. This can be effected, for example, by means of a gripper arm or a tilting apparatus. The magazine is preferably a closed container. Since photosensitive flexographic printing elements have to be protected from UV light, the room in which the novel apparatus is installed need not as a whole be protected from UV light in the case of a closed container.

The unit (B) serves for the digital imaging of the flexographic printing elements. It comprises at least two functional units of the same type for digital imaging. Preferably, unit (B) comprises a large number of functional units of the same type for digital imaging. There may be, for example, from 5 to 50 functional units. Through the cooperation of a relatively large number of functional units, faster imaging of the flexographic printing element is achieved. As a result of the action of the functional units on the digitally imageable layer of the flexographic printing element, a mask is produced on the flexographic printing element.

The term functional units of the same type does not necessarily mean that the functional units have to be identical. It merely means that functional units operating according to the same principle should cooperate, i.e. for example only IR lasers or only inkjet printing heads. However, these can be appropriately designed depending on the desired function. For example, one type of functional unit can be specially adapted to the recording of relatively coarse structures and the other type to the recording of finer structures. The individual functional units are each individually controlable.

The functional units are usually arranged above the flexographic printing element, so that they can produce an image on the digitally imageable layer as far as possible perpendicularly from above. However, arrangements in which the functional units are arranged in a different manner are also conceivable.

Furthermore, a relative movement between the functional units and the flexographic printing element on which an image is to be produced must be effected for imaging. For this purpose, the plate, the functional units or both can be moved. The movement of the functional units can furthermore be effected by movement of the entire unit. Also possible, however, would be, for example, a stationary laser source in which only the laser beam is guided, for example via a system of mirrors.

An example of an expedient arrangement of the functional unit is shown in the drawing. Here, 10 functional units are arranged along a bar (3). A photosensitive flexographic printing element (1) having a digitally imageable layer is passed under the bar (3) in the x direction. Alternatively, the flexographic printing element can be fixed, while the bar is moved in the x direction. Each of the ten functional units produces an image on in each case one part (2) of the digitally imageable layer with the width (y). For this purpose, the functional unit can be moved back and forth, for example in the y direction, and the functional units are switched on and off according to the desired image. Expediently, the functional units are not moved individually but the entire bar (3) is moved back and forth in the y direction. However, other movement sequences are of course also possible. Unit (B) furthermore comprises a regulation unit for synchronizing the translational movement x with the movement of the functional units. It is of course also possible to use such a large number of functional units that uniform imaging of the flexographic printing element is possible even with a stationary bar.

Other arrangements of the functional units are also possible. For example, two or more bars can be arranged one behind the other, or the functional units can be offset relative to one another. For example, the arrangements disclosed in DE-A 100 57 061 or DE-A 37 30 844 can be used.

The type of functional units depends on the type of digitally imageable layer. For the imaging of flexographic printing elements having opaque, IR-ablative layers, IR lasers are used. These are preferably diode lasers, without it being intended to limit the present invention to these. Here, the opaque, IR-ablative layer is removed in the parts where a laser beam is incident on them, and the photopolymerizable layer underneath is bared. To prevent the novel apparatus from being contaminated by the degradation products of the layer, in this embodiment the imaging unit should expediently have an extraction apparatus.

Imaging by means of the inkjet technique is effected according to the opposite principle. The digitally imageable layer is transparent, and those parts which are not to be crosslinked are covered by opaque ink. The functional units are accordingly inkjet printing heads.

Thermographic, digitally imageable layers are transparent and become opaque under the action of heat. Suitable functional units for recording on thermographic layers are, for example, IR lasers or thermal printing heads.

The imaging unit (B) is expediently modular, so that the functional units can easily be changed according to the desired imaging technique.

The exposure unit (C) comprises suitable radiation sources for crosslinking the desired parts of the photopolymerizable layer. UVA radiation or UVA/VIS radiation is particularly suitable for this purpose. The radiation source may comprise, for example, tubes or suitably arranged point light sources. Exposure is usually effected in the presence of atmospheric oxygen. Optionally, however, the exposure unit can also be equipped for exposure under an inert gas, such as nitrogen or argon.

The washout unit (D) comprises means for treating the exposed flexographic printing element with a suitable washout agent, for example by spraying or immersion. It furthermore usually comprises moving brushes or fleeces for accelerating the removal of the unpolymerized monomer. Furthermore, the washout unit usually comprises suitable means for feeding in fresh washout agent and for removing spent washout agent.

The drying unit (E) serves for drying the moist flexographic printing element. It may consist, for example, of a heatable chamber or drying tunnel. The heat can be supplied, for example, via built-in heating elements. However, a warm drying gas stream may also advantageously flow through the drying unit. Of course, the possibilities for heating can also be combined with one another. The dryer used should be an exit air dryer, for suppressing the accumulation of solvent in the gas space. The solvent concentration in the gas space should be below the lower explosion limit. A drying gas stream can also advantageously be circulated, washout agent which has escaped from the flexographic printing plate being separated off in an apparatus suitable for this purpose and the depleted drying gas stream being recycled into the drying unit. The removal of the solvent can be effected, for example, by condensation at lower temperatures or absorption in suitable absorbers.

The aftertreatment unit (F) is not absolutely necessary in every case and is therefore only optional. However, it is generally advisable for rendering the surface of the resulting flexographic printing plate nontacky. The aftertreatment unit comprises suitable radiation sources for irradiation of the flexographic printing plate with UV-A and/or UV-C light.

The output unit (G) serves for delivering the finished flexographic printing plate. In the simplest case, it may be a simple output apparatus from which the flexographic printing plates are manually removed. For example, the flexographic printing plate can be discharged from the aftertreatment unit (F) onto a conveyor belt. The output unit (G) can, however, also comprise a magazine which is capable of holding a relatively large quantity of finished flexographic printing elements.

The transport units (H) connect the units (A) to (G) to one another and ensure the transport of the flexographic printing elements or plates from one unit to the next unit. The transport unit can, if required, also be combined with the transport units which ensure the transport of the flexographic printing elements or plates inside the units (B) to (F). It is conceivable for the flexographic printing elements or plates to be passed through the entire novel apparatus on a single transport apparatus. The transport apparatus may be, for example, a conveyor belt on which the flexographic printing element is placed and is held by means of suitable retaining apparatuses, for example pins on the belt, and is transported.

In a particularly advantageous embodiment of the invention, the transport apparatus comprises magnetic retaining apparatuses. In combination therewith, a flexographic printing element which comprises a metallic substrate of a magnetizable material is used. For example, it is possible to use a conveyor belt which comprises magnets. The metallic substrate is held on the belt by these magnets and thus drawn through the apparatus. Both permanent magnets and electromagnets are possible.

Of course, other designs of the transport units are also conceivable. The flexographic printing elements or plates can, for example, be transferred from one unit to the next by gripper arms.

If necessary, the transport means may furthermore have locks or equivalent separating apparatuses which serve for separating the individual units from one another and are intended to avoid adverse effects by undesirable influences of the individual units on each other. The design depends on the respective units to be separated. A separating unit is usually advisable in particular between the wash apparatus and the dryer.

The flexographic printing elements or plates are transported by means of the transport units likewise with the plates in a flat state.

Optionally, the novel apparatus may also comprise further functional units. If the photopolymerizable flexographic printing element used as starting material comprises a protective film on the digitally imageable layer, the novel apparatus may furthermore comprise a unit (A′) by means of which the protective film is automatically removed. Furthermore, it is possible to provide a preexposure unit (A″) by means of which the entire photopolymerizable layer is preexposed before the digital imaging by means of UV-A light.

The novel apparatus can be used for the production of flexographic printing plates starting from conventional digitally imageable, photopolymerizable flexographic printing elements, at least comprising a substrate, photopolymerizable layer and digitally imageable layer. The use is not limited to specific types of flexographic printing elements. For example, thick flexographic printing plates having a thickness of from 2 to 4 mm can also be processed.

The novel apparatus is very particularly advantageously used for the novel process for the production of newspaper flexographic printing plates.

A photopolymerizable flexographic printing element which comprises—arranged one on top of the other—at least one flexible metallic substrate, a photopolymerizable layer and a digitally imageable layer is used as starting material for the novel process.

Particularly suitable flexible metallic substrates are thin metal sheets or metal foils of steel, preferably of stainless steel, magnetizable spring steel, aluminum, zinc, magnesium, nickel, chromium or copper, it also being possible for the metals to be alloyed. In the context of this invention, flexible is to be understood as meaning that the substrates are so thin that they can be bent around printing cylinders. On the other hand, they are also dimensionally stable and so thick that the substrate is not buckled during the production of the flexographic printing element or the mounting of the finished printing plate on the printing cylinder. Combined metallic substrates, for example steel sheets coated with tin, zinc, chromium, aluminum, nickel or combinations of different metals, may also be used, or those metal substrates which are obtained by laminating metal sheets of the same type or of different types. Furthermore, pretreated metal sheets, for example phosphated or chromatized steel sheets or anodized aluminum sheets, may also be used. As a rule, the metal sheets or foils are degreased prior to use. Substrates of steel or aluminum are preferably used, magnetizable spring steel being particularly preferred.

The thickness of such flexible metallic substrates is usually from 0.025 to 0.4 mm and depends on the type of metal used, in addition to the desired degree of flexibility. Steel substrates usually have a thickness of from 0.025 to 0.25 mm, in particular from 0.14 to 0.24 mm. Aluminum substrates usually have a thickness of from 0.25 to 0.4 mm.

The flexible metallic substrate advantageously has an adhesion-promoting layer present thereon. The adhesion-promoting layer imparts good adhesion between the flexible, metallic substrate and the photopolymerizable layer subsequently to be applied, so that the printing elements obtained by imagewise exposure of the photopolymerizable layer do not break, are not delaminated and do not buckle either during development of the plate or during printing.

In principle, any desired adhesion-promoting layers can be used, provided that they impart sufficient adhesion. The adhesion-promoting layer particularly advantageously comprises a UV absorber. The UV absorber prevents UV light from being scattered back into the relief layer by the metallic substrate. Such reflections can in certain circumstances reduce the exposure latitude and adversely affect the possible resolution. Adhesion-promoting layers particularly suitable for carrying out the invention are disclosed, for example, in DE-A 100 40 929.

The flexographic printing element used as starting material furthermore comprises a photopolymerizable layer, which in turn comprises at least one elastomeric binder, ethylenically unsaturated monomers and a photoinitiator or a photoinitiator system. Optionally, further components, for example plasticizers or assistants, may also be present.

The photopolymerizable layer may comprise a plurality of photopolymerizable layers one on top of the other, which have the same composition, roughly the same composition or different compositions. A multilayer structure has the advantage that the properties of the surface of the printing plate, for example ink transfer, can be changed without influencing the properties of the printing plate which are typical for flexographic printing, for example hardness or resilience. Surface properties and layer properties can thus be changed independently of one another in order to achieve an optimum printed copy.

The binders may be either elastomeric or thermoplastic elastomeric binders which are usually used for the production of flexographic printing elements. Examples include the known block copolymers of the styrene/isoprene and styrene/butadiene type. Further examples include elastomeric polymers of the ethylene/propylene/diene type or elastomeric polymers based on acrylates or acrylate copolymers. A person skilled in the art makes a suitable choice from among the elastomers suitable in principle, depending on the desired properties of the layer. The amount of elastomeric binder in the relief layer is as a rule from 40 to 90% by weight, based on the amount of all components. Preferably from 40 to 85%, particularly preferably from 40 to 75%, are used.

The photosensitive layer furthermore contains compounds polymerizable in a known manner, i.e. monomers. The monomers should be compatible with the binder and should have at least one polymerizable, ethylenically unsaturated double bond. Examples of suitable monomers include (meth)acrylates, such as butyl (meth)acrylate, 2-ethylhexyl (meth)acrylate, lauryl (meth)acrylate, 1,4-butanediol di(meth)acrylate and 1,6-hexanediol di(meth)acrylate. The amount of monomers in the photopolymerizable layer is as a rule from 4.9 to 30, preferably from 4.9 to 20, % by weight, based on the amount of all components.

The photopolymerizable layer furthermore has, in a manner known in principle, a photoinitiator or a photoinitiator system. Examples of suitable initiators are benzoin and benzoin derivatives, such as methylbenzoin or benzoin ethers. The amount of photoinitiator in the relief layer is as a rule from 0.1 to 5% by weight, based on the amount of all components.

The photopolymeric layer can optionally comprise further components, for example thermal polymerization inhibitors, plasticizers, dyes, pigments, photochromic additives, antioxidants, further binder for precision control of the properties or extrusion assistants. As a rule, however, more than 10% by weight of such additives is used.

In a preferred embodiment of the novel process, the starting material used is a digitally imageable flexographic printing element in which a styrene/butadiene block copolymer having a styrene content of from 20 to 50, preferably from 25 to 45, particularly preferably from 25 to 35, % by weight is used as the elastomeric binder in the photopolymerizable layer. The SBS block copolymer preferably has a Shore A hardness of from 50 to 80, according to ISO 868. The Shore A hardness is particularly preferably from 55 to 75, very particularly preferably from 60 to 75. It should furthermore have a weight average molecular weight M_{w} of from 80 000 to 150 000, preferably from 90 000 to 140 000, particularly preferably from 100 000 to 130 000, g/mol. Suitable SBS polymers are obtainable, for example, under the name Kraton®.

In the preferred embodiment, the binder is used in combination with a suitable plasticizer. Mixtures of different plasticizers may also be used. Examples of suitable plasticizers include paraffinic mineral oils; esters of dicarboxylic acids, such as dioctyl adipate or dioctyl terephthalate; naphthenic plasticizers or polybutadienes having a molecular weight of from 500 to 5 000 g/mol. The amount of plasticizer in the photopolymeric layer is usually from 5 to 50% by weight, based on the amount of all components. The exact amount is chosen by a person skilled in the art according to the binder used and the desired hardness of the printing plate. Preferably from 10 to 40%, particularly preferably from 20 to 35%, are used.

The digitally imageable layer is preferably a layer selected from the group consisting of the IR-ablative layers, inkjet layers and thermographic layers.

IR-ablative layers or masks are opaque to the wavelength of actinic light and usually comprise at least one binder and an IR absorber, for example carbon black. Carbon black also ensures that the layer is opaque. A mask can be recorded in the IR-ablative layer by means of an IR laser, i.e. the layer is decomposed and ablated in the parts where the laser beam is incident on it. Imagewise exposure to actinic light can then be effected through the resulting mask. Examples of the imaging of flexographic printing elements using IR-ablative masks are disclosed, for example, in EP-A 654 150 or EP-A 1 069 475.

In the case of inkjet layers, a layer recordable with inkjet inks, for example a gelatin layer, is applied. An image can be recorded thereon by means of inkjet printers. Examples are disclosed in EP-A 1 072 953.

Thermographic layers are layers which contain substances which become black under the influence of heat. Such layers comprise, for example, a binder and an organic silver salt and can be provided with an image by means of a printer having a thermal head or by means of IR lasers. Examples are disclosed in EP-A 1 070 989.

The flexographic printing element used as starting material can be produced, for example, by dissolving the components of the photopolymerizable layer, of the digitally imageable layer and optionally of the adhesion-promoting layer in each case in a suitable solvent and applying them layer-by-layer in succession on the metallic substrates. Optionally, a protective film, for example of PET, can finally be applied. Alternatively, the layers can be cast in the reverse sequence onto the protective film and the metallic substrate finally laminated therewith. A suitable process is disclosed, for example, in DE-A 100 40 929.

The preferred total thickness of the flexographic printing element comprising metallic substrate, adhesion-promoting layer, photosensitive layer and digitally imageable layer—without an optionally present protective film—is preferably from 400 to 1 000 □m, particularly preferably from 400 to 800 □m, very particularly preferably from 450 to 750 □m.

For carrying out the novel process, the starting material is first placed in the holding unit (A) in step (a), for example by placing on a conveyor belt or loading the magazine. If the starting material has a protective film, this must be peeled off if the holding unit has no automatic peeling apparatus.

In a particularly advantageous embodiment of the novel process, the flexographic printing element is preexposed uniformly to actinic light in a step preceding step (b). The quantity of light is limited so that the photopolymerizable layer is still soluble in the developer even after the preexposure; the layer therefore must not crosslink. In general, an exposure time of a few seconds is sufficient for this purpose. This step is by its nature possible only in the case of flexographic printing elements having transparent masks, i.e. for example in the case of inkjet masks or thermographic masks. Flexographic printing elements which have an opaque digitally imageable layer can by their nature not be preexposed.

In process step (b), the digitally imageable layer is provided with an image by means of the respective required technique in the imaging unit (B). The image information is taken directly from a control unit.

In process step (c), the flexographic printing element provided with an image is exposed to actinic, i.e. chemically active, light by means of the exposure unit (C), through the mask produced. UV-A/VIS radiation or UV-A radiation is preferred here. Depending on the type of flexographic printing element, however, other radiation sources may also be used. The photopolymerizable layer polymerizes thereby in the transparent parts of the mask and remains uncrosslinked in the parts covered by the mask.

In process step (d), the imagewise exposed flexographic printing element provided with an image is developed by means of a suitable solvent or a solvent combination. Here, the unexposed parts of the relief layer, i.e. the parts thereof which have been covered by the mask, are removed, while the exposed parts, i.e. the crosslinked parts, are retained. Furthermore, the residues of the digitally imageable layer are removed. The solvent or solvent mixture used depends on the type of flexographic printing element used. If the flexographic printing element has a photopolymerizable layer which can be developed in an aqueous medium, water or predominantly aqueous solvents can be used. For flexographic printing elements which can be developed in an organic medium, the known washout agents for flexographic printing plates, which usually consist of mixtures of different organic solvents which cooperate in a suitable manner, are particularly suitable. For example, developers comprising naphthenic or aromatic mineral oil fractions as a mixture with alcohols, for example benzyl alcohol or cyclohexanol, and, if required, further components, such as alicyclic hydrocarbons, terpene hydrocarbons, substituted benzenes, for example diisopropylbenzene, or dipropylene glycol dimethyl ether, can be used. Suitable washout agents are disclosed, for example, in EP-A 332 070 or EP-A 433 374.

The development step is usually carried out at above 30° C. In a preferred embodiment of the invention, the development step is carried out at higher temperatures owing to the higher washout rates achievable. For safety reasons and for reducing the complexity of the development apparatus, the temperature when organic solvents are used should be from 5 to 15° C. below the flashpoint of the washout agent used.

The drying of the flexographic printing plates in process step (e) is preferably effected at from 105 to 160° C., particularly preferably from 120 to 15° C.

If the novel apparatus has an aftertreatment unit (F), the flexographic printing plates obtained can, if required, also be subjected to an aftertreatment with UV-A and/or UV-C light for eliminating tack in process step (f). As a rule, such a step is advisable. If exposure to light of different wavelengths is intended, it can be effected simultaneously or in succession. Finally, the finished flexographic printing plate is delivered via the output unit (G)

Between the individual process steps, the flexographic printing element or the flexographic printing plate is transported in each case by means of the transport unit (H) from one unit to the next unit. The flexographic printing element or the flexographic printing plate must not be bent in any of the process steps; on the contrary, the flexographic printing element or the plate passes flat through all steps.

The novel process permits rapid processing of flexographic printing elements to give the finished newspaper flexographic printing plates. In the case of the newspaper flexographic printing plates described, processing times of substantially less than 30 min are as a rule achieved.

1-16. (canceled)

17. An apparatus for the in-line production of flexographic printing plates by means of digital imaging, at least comprising
(A) a unit for holding digitally imageable, photopolymerizable, flexographic printing elements having a thickness of from 0.4 to 1.0 mm,
(B) a unit for the digital imaging of the flexographic printing element, which comprises at least two functional units of the same type, selected from the group consisting of thermal printing heads, of IR lasers, inkjet printing heads or thermal printing heads,
(C) an exposure unit,
(D) a washout unit,
(E) a drying unit,
(F) optionally an aftertreatment unit,
(G) an output unit for the flexographic printing plates obtained, and
(H) transport units for the flexographic printing elements or plates, which connect the units (A) to (G) to one another,
the units (A) to (H) being designed so that the flexographic printing elements or plates are processed in the flat state.

18. An apparatus as claimed in claim 17, wherein the transport units comprise magnetic retaining apparatuses.

19. An apparatus as claimed in claim 17, which furthermore comprises a unit for preexposure of the photosensitive flexographic printing elements.

20. The use of an apparatus as claimed in claim 17 for the production of flexographic printing plates.

21. A process for the production of flexographic printing plates for newspaper printing, in which the starting material used is a photosensitive flexographic printing element having a thickness of from 0.4 to 1.0 mm comprising—arranged one on top of the other—at least
a flexible, metallic substrate,
a photopolymerizable layer which in turn comprises at least one elastomeric binder, ethylenically unsaturated monomers and a photoinitiator, and
a digitally imageable layer,
wherein an apparatus as claimed in claim 17 is used and the process comprises the following steps:
(a) placing of the photosensitive flexographic elements in the holding unit (A),
(b) imagewise recording on the digitally imageable layer by means of the imaging unit (B) for producing a mask on the flexographic printing element,
(c) exposure of the flexographic printing element to actinic light by means of the exposure unit (C) through the mask produced,
(d) removal of unexposed parts of the flexographic printing element and the residues of the digitally imageable layer by means of a suitable solvent or of a suitable solvent combination in the washout unit (D),
(e) drying of the washed out flexographic printing plate at from 105 to 160° C. in the drying unit (E),
(f) optionally aftertreatment of the dried flexographic printing plate by means of UVA and/or UVC light and
(g) output of the finished flexographic printing plate,
the flexographic printing element or the flexographic printing plate being transported by the transport means (H) from one unit to the respective next unit and not being bent during the entire processing procedure.

22. A process as claimed in claim 21, wherein the flexographic printing element is furthermore preexposed to actinic light in a step preceding (b), with the proviso that a flexographic printing element whose digitally imageable layer has a sufficient transparency to actinic light is used.

23. A process as claimed in claim 21, wherein the metallic substrate comprises magnetizable spring steel.

24. A process as claimed in claim 21, wherein the binder in the photopolymerizable layer is at least one styrene/butadiene block copolymer having a styrene content of from 20 to 50% by weight.

25. A process as claimed in claim 24, wherein the block copolymer has an average molecular weight M_{w} of from 80 000 to 150 000 g/mol.

26. A process as claimed in claim 24, wherein the styrene/butadiene block copolymer has a Shore A hardness of from 55 to 75.

27. A process as claimed in claim 24, wherein the photopolymerizable layer furthermore comprises from 5 to 50% by weight of a plasticizer.
